(19) United States
(12) Patent Application Publication
(10) Pub. No.: US 2020/0125341 A1
(43) Pub. Date: Apr. 23, 2020

(54) ASSISTIVE VISUAL LAYOUT SELECTION

(71) Applicant: Google LLC, Mountain View, CA (US)

(72) Inventors: Damon Brien SEELEY, Sunnyvale, CA (US); Michael Efim DYNIN, Mountain View, CA (US); Kristopher David GIESING, Palo Alto, CA (US); Lee Brandon KEELY, San Francisco, CA (US); Emily Rebecca SHACK, Mountain View, CA (US)

(21) Appl. No.: 16/168,729

(22) Filed: Oct. 23, 2018

(51) Int. Cl. G06F 8/38; G06F 8/34; G06F 3/0484

(52) U.S. Cl. CPC G06F 8/38; G06F 3/04847; G06F 8/34

(57) ABSTRACT

A designer application is used to generate multiple design layouts, each comprising a different arrangement of visual elements selected from a predetermined set of visual elements for a different presentation size. The designer application then displays a presentation interface partitioned into a number of respective sample spaces each corresponding to a different presentation size. A first of the multiple design layouts is displayed in the presentation interface, in connection with a first sample space of the respective sample spaces. In response to the size of the first design layout being adjusted to within a predetermined distance of, or to overlap, a second sample space, the designer application automatically changes the display of the first design layout to a display of a second design layout having the presentation size associated with the second sample space, with a different arrangement of visual elements from the predetermined set of visual elements.

### BACKGROUND

User interface design and construction is often time consuming. Automation of user interface designs is complex, use fixed rules, and is difficult to scale. Moreover, traditional user interface designs are developed on a case by case basis, with each design being generated for a particular resolution or screen size.

### SUMMARY

The subject technology provides a system and computer-implemented method for designing and generating user interfaces. In some implementations, a method comprises identifying multiple design layouts, each comprising a different arrangement of visual elements selected from a predetermined set of visual elements for a different presentation size, displaying, responsive to generating the multiple design layouts, a presentation interface partitioned into a number of respective sample spaces corresponding to the different presentation sizes of the design layouts, receiving a selection to view the multiple design layouts in the presentation interface, displaying, responsive to receiving the selection, a first design layout of the multiple design layouts in the presentation interface and in connection with a first sample space of the respective sample spaces, receiving a command to adjust a size of the first design layout while the first design layout is displayed within the presentation interface, and, in response to the size of the first design layout being adjusted to within a predetermined distance of, or to overlap, a second sample space of the respective sample spaces, automatically changing the display of the first design layout to a display of a second design layout having the presentation size associated with the second sample space and a different arrangement of visual elements selected from the predetermined set of visual elements than the first design layout.

In some implementations, each of the respective sample spaces is arranged in the presentation interface, according to its corresponding presentation size, and the respective sample spaces are displayed as being separated within the presentation interface by a number of visual partitions, the number of visual partitions based on the number of respective sample spaces, wherein a height or width dimension of a respective sample space changes within the presentation interface with respect to one or more of the visual partitions that border the respective sample space, the height or width dimension of the respective sample space being proportional to the height or width dimension of its associated presentation size with respect to the height or width of presentation sizes of other sample spaces in the presentation interface along a same dimension. In some implementations, the method further comprises generating a new design layout at a new presentation size, and automatically adding to the respective sample spaces, in response to generating the new design layout at the new presentation size, a new sample space corresponding to the new presentation size, and automatically adjusting displayed areas of the respective sample spaces within the presentation interface to accommodate a display of the new sample space within the presentation interface. In some implementations, the changing of the display of the first design layout is also based on the size of the first design layout being adjusted beyond a threshold size associated with the first sample space and in a direction toward the second sample space. Other aspects include corresponding systems, apparatuses, and computer program products for implementation of the computer-implemented method.

In one or more implementations, the system comprises one or more processors and a memory comprising instructions stored thereon that, when executed by the one or more processors, cause the one or more processors to perform operations. In some implementations, the operations comprise identifying multiple design layouts, each comprising a different arrangement of visual elements selected from a predetermined set of visual elements for a different presentation size, displaying, responsive to identifying the multiple design layouts, a presentation interface partitioned into a number of respective sample spaces corresponding to the different presentation sizes of the design layouts, displaying, in connection with displaying the presentation interface, a first design layout of the multiple design layouts in the presentation interface and in connection with a first sample space of the respective sample spaces, receiving a command to adjust a size of the first design layout while the first design layout is displayed within the presentation interface, and, in response to the size of the first design layout being adjusted to within a predetermined distance of, or to overlap, a second sample space of the respective sample spaces, automatically changing the display of the first design layout to a display of a second design layout having the presentation size associated with the second sample space and a different arrangement of visual elements selected from the predetermined set of visual elements than the first design layout. Other aspects include corresponding methods, apparatuses, and computer program products for implementation of the operations.

In one or more implementations, a non-transitory computer-readable medium having instructions stored thereon that, when executed, cause a computing device to perform a method, comprising identifying multiple design layouts, each comprising a different arrangement of visual elements selected from a predetermined set of visual elements for a different presentation size, displaying, responsive to identifying the multiple design layouts, a presentation interface partitioned into a number of respective sample spaces corresponding to the different presentation sizes of the design layouts, displaying, in connection with displaying the presentation interface, a first design layout of the multiple design layouts in the presentation interface and in connection with a first sample space of the respective sample spaces, receiving a command to adjust a size of the first design layout while the first design layout is displayed within the presentation interface, and, in response to the size of the first design layout being adjusted to within a predetermined distance of, or to overlap, a second sample space of the respective sample spaces, automatically changing the display of the first design layout to a display of a second design layout having the presentation size associated with the second sample space and a different arrangement of visual elements selected from the predetermined set of visual elements than the first design layout. Other aspects include corresponding methods, systems, apparatuses, and computer program products for implementation of the machine-readable medium.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 depicts an example designer application for the design and generation of displayable design layouts based on a master design layout.

FIG. 2 depicts an example design layout created by a design tool of the example designer application of FIG. 1.

FIGS. 3A and 3B are illustrations of an example design application, including a first example presentation interface for display of two different design layouts at different presentation sizes.

FIGS. 4A to 4D depict a second example presentation interface with four sample spaces having been generated based on the selection of four modes for four different presentation sizes.

FIG. 5 depicts a third example presentation interface including a visual score for respective sample spaces.

FIG. 6 depicts an example process for the quick generation and selection of visual layouts for graphically displayable design layouts.

FIG. 7 is a diagram illustrating an example electronic system for the quick generation and selection of visual layouts for graphically displayable design layouts.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology provides a user interface-driven design system that facilities the quick generation and selection of layouts for graphically displayable user interface (UI) modules. A designer application is used to generate multiple design layouts, each comprising a different arrangement of visual elements selected for a different presentation size. The designer application then displays (responsive to generating the multiple design layouts) a presentation interface (e.g., a graphical window for direct manipulation of graphical elements) partitioned into a number of respective sample spaces corresponding to the number of different presentation sizes indicated by the generated design layouts. The number of partition spaces may correspond to, for example, a number of design layouts selected by a user designer.

The presentation interface displays a first of the design layouts, for example, in a first sample space near a corner of the display area. In response to the size of the first design layout being adjusted to within a predetermined distance of, or to overlap, a second sample space of the respective sample spaces, the designer application automatically changes the display of the first design layout to a display of a second design layout. The second design layout has a presentation size (e.g., a display area measurable in pixels) associated with the second sample space and an arrangement of visual elements selected from the predetermined set of visual elements that is different than the first design layout.

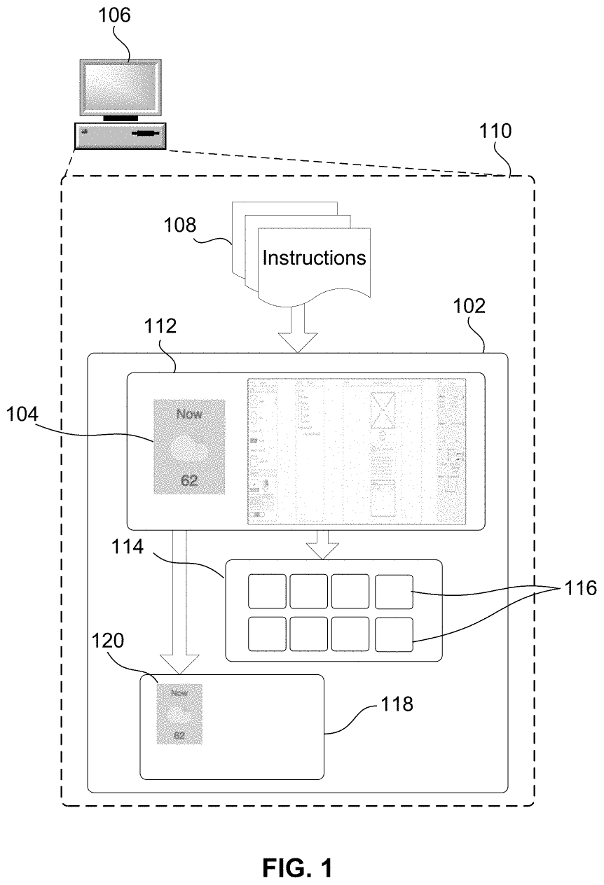

Developing a “one size fits all” graphical user interface, or developing interfaces on a case by case basis, has traditionally posed many different technical problems, including determining how a particular group of visual elements would look when displayed on different devices having a different overall resolution or screen orientation. In this regard, a user designer seeking to adapt one user interface to multiple different devices traditionally must select new visual elements and arrange the new elements in a new layout for each device, before the graphical user interface can be viewed on the device. Moreover, the user designer also must close and reopen each different design layout—often within a different mock interface corresponding to each desired resolution or screen size—to check its suitability for a particular resolution or screen size. The subject technology disclosed herein provides a technical solution to these problems by providing an application that allows a user designer to dynamically compare multiple layouts developed for different presentation sizes within a single user interface, and without having to close and reopen each design layout in a different environment. Additionally, the subject technology provides a visual indication within the user interface, based on predetermined scoring criteria, of the suitability of a respective design layout at each presentation size. This visual indication also provides immediate feedback to a user designer as to whether other design layouts should be created that would have better suitability for a given presentation size. FIG. 1 depicts an example designer application 102 for the design and generation of displayable design layouts based on a master design layout 104, according to one or more aspects of the subject technology. During operation of a computing device 106, executable instructions 108 are loaded into a runtime environment 110 and executed. Instructions 108, when executed, create designer application 102, and may perform a number of operations upon data provided for display in designer application 102.

The designer application 102 may include, for example, a design tool 112, such as a schematic designer, that enables a user designer to visually build (e.g., using design controls) a master design layout 104 using various console inputs and drag-and-drop operations. A master design layout may be visually represented at runtime by multiple design layouts, each with a different arrangement of visual elements for a given presentation size. The term “presentation size” as used herein means a size of a displayed item or object having at least two transverse dimensions (e.g., a height and a width) of a measurable length (e.g., in pixels). The dimensions of a design layout may be for any shape, including rectangular, circular, elliptical, ovate, triangular, or polygonal, and design layouts may be scaled in any direction to change the size or shape of the module. As will be described further, the designer application 102 may include an automated design interface 114 that generates candidate design layouts 116, and a presentation interface 118 for display of a selected design layout 120 (or “mode”).

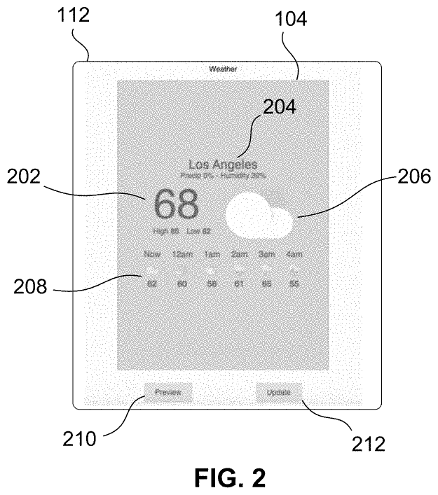

FIG. 2 depicts an example design layout 104 for a design layout created by the design tool 112 of designer application 102 of FIG. 1, according to various aspects of the subject technology. A weather module is depicted that includes a temperature element 202, a location element 204, and one or more graphics 206. The depicted example is one implementation of a module that may be created using the design application, as many types of modules are also conceivable.

Each design layout 104 (and corresponding design layouts) may include multiple different elements. An element represents a visual item or a component. An “item”, for example, may include, for example, text or graphics. Accordingly, an element may represent an item or a collection of items. According to various implementations, a visual “component” is a building block that can be created from items or other elements, displayed, and saved (e.g., to storage medium) so that it can be used in larger designs (e.g., a design layout).

With reference to FIG. 1, using the design tool 112, a user designer may assign a background color to a design layout (and its corresponding design layouts). To construct the module, each visual component may be added to a design layout template (e.g., a canvas) by selection from a list, or by dragging the component from a list of components onto the template. Components may include static content or properties, or content or properties bound to a data source. Data sources may include databases or web-accessible data services that provide information in real time. In this regard, bound components, when rendered, may update their content or properties in real time based on receiving information from its associated data source.

The depicted weather module includes a time weather component that is bound to a data source that indexes temperature based on time for a particular day. Components may wrap other components. For example, in the depicted example of FIG. 2, a day temperature component 208 wraps the time weather component in a group of six copies. Other elements (such as text) used in a design layout may be given static content (instead of a data binding).

Each visual element or component may include one or more properties that each has multiple display options that can be selected from. Each set of options may be referred to as a decision set. According to one example, a decision set may include a set of visual elements being as a column or alternatively displayed as a row to better fit wider sizes. As another example, a decision set may include three different colors, which can be changed or cycled during design time or, in some implementations, at run time. This “optionality” can be extended further using styles and themes to group property decisions. Themes are collections of styles, and styles are collections of property values. For example, a top group style may have three different options, each of which has a different set of values for component spacing, arrangement and padding. Styles can be applied to multiple components, propagating the same decisions across all components. For example, a unique style may be applied to each visual component displayed design layout template. In this regard, each element may have multiple predetermined arrangements that can be selected during the design process. As described further below, selections of the decisions sets for a particular design layout may occur automatically by a design search algorithm.

In some implementations, optionality may be expressed by arrangement of a design according to a hierarchical structure, wherein a top level group is created by the user designer, along with an option of a different child ordering for the components. An option may be further refined by adjusting the properties of a group of components.

The user designer may set the presentation size of the design surface canvas to accommodate all of the components that are to be added to a design. A preview selection control 210 may be selected or activated to display a preview of each selectable option. In some implementations, the user designer may select the control to preview the design layout design in the presentation interface 118, and adjust the size of the design in the presentation interface to further determine whether the design meets expectations. If not happy with the design, the user designer may make changes to the design (e.g., by moving components on the canvas, replacing and/or rearranging components, adjusting individual component sizes, etc.) and using the automated design interface to find something better. An update control 212 may be selected or activated to initiate a search algorithm to determine multiple different candidate design modes for selection by the user designer.

In some implementations, the executable instructions 108 may implement, as part of designer application 102, an automated design interface 114. The automated design interface 114 includes an automated search system that quickly generates a user interface based on a search algorithm. According to various implementations, the automated design interface 114 may implement the automated design interface described in U.S. application Ser. No. 15/464,279, filed Mar. 30, 2018 and entitled “Automated Interface Design,” which is incorporated herein by reference in its entirety for that purpose. When a design module layout is completed in design tool 112 it may be sent to the automated design interface 114, which then automatically generates multiple candidate design modes 116 based on a series of algorithmic operations. The algorithmic operations may include traversing a design tree that represents a design space of all possible interfaces that may be implemented in an example final user interface design to construct the candidate design modes. Each mode is a different version or different layout of the same visual elements or components selected for use in the design being constructed based on the decision sets associated with the elements selected for the design. Accordingly, the automated design interface 114 may generate different candidate design modes of the design layout constructed in design tool 112 with all decision sets resolved.

Each candidate design mode 116 may be generated based on a predetermined presentation size for the canvas of the master design layout. For example, a first design layout may be generated for display at or up to a presentation size of 600 by 800 pixels. In this regard, the design application receives a selection of the presentation size and plurality of visual elements for the first design layout. One or more of the visual elements used in the first design layout may include multiple options (e.g., a decision set) such that, when multiple candidate design modes 116 are generated by the automated design interface 114 for the first design layout, each may be generated with a different arrangement of visual elements based on the optionality set in the design tool 112. Multiple modes 116 may be displayed by the automated design interface 114 for selection by the user designer.

Once a candidate design mode 116 is selected, it may then be displayed in a presentation interface 118 for review by the user designer (e.g., using control 210 or update 212 followed by a selection of a candidate design mode). The user designer may instantly view how the design layout looks and stretch it to different sizes by interaction with a pointer device and the display screen using click and drag operations. If the user designer is not happy with a selected design, the user designer may select another candidate mode 116 and the presentation interface 118 may automatically display the newly selected mode.

According to various aspects, the design application 102 may be used to create a second (or alternative) design layout for different (second) presentation size. For example, the user designer may create a second design layout for display at or up to a presentation size of 720 by 1080 pixels. The second design layout may include visual elements selected from the same predetermined set of visual elements used to construct the first design layout. More or less elements may be selected based on a selected presentation size for the second design layout. Once arranged in the second design layout, the automated design interface 114 may then be used to automatically determine second plurality of candidate modes 116 of the second layout design at this second presentation size, with each of second plurality of candidate modes 116 including the same set of visual elements but in a different arrangement for the second layout design according to the set optionality for the elements in the layout. Using the design tool 112, a user designer may modify the decision sets to accommodate layouts of all (e.g., first and second) presentation sizes and/or orientations, or create different decision sets for each presentation size or orientation. A selected mode 120 may then be selected and displayed in the presentation interface 118.

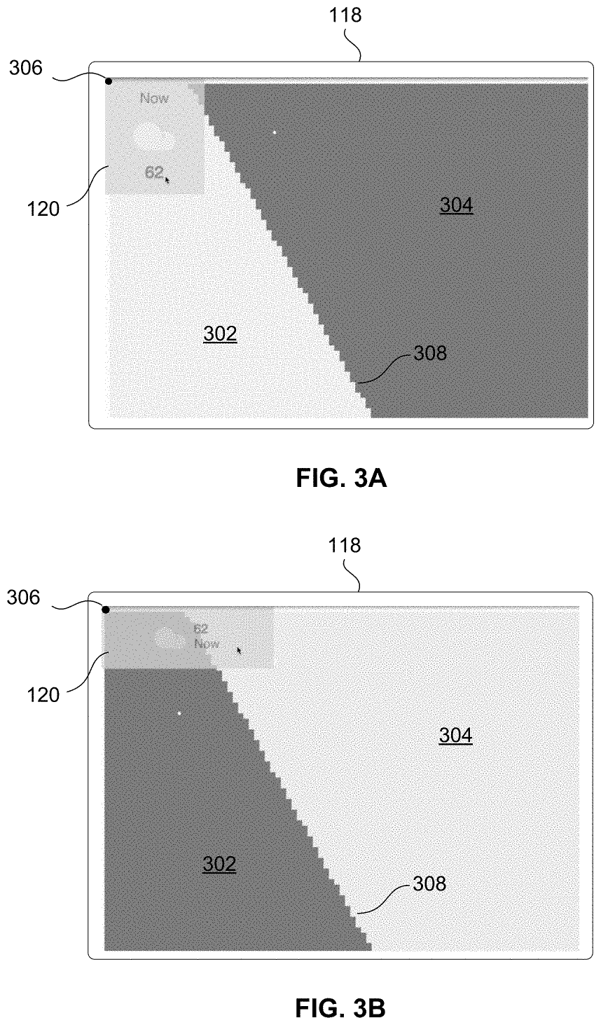

FIGS. 3A and 3B are illustrations of an example design application, including an example presentation interface 118 for display of two different design layouts at different presentation sizes, according to various aspects of the subject technology. The presentation interface 118 is generated and displayed, responsive to selecting modes, as described above, and each selected mode being identified by the design application as the design layout for a particular presentation size. The presentation interface 118 is partitioned into a number of respective sample spaces corresponding to a number of different presentation sizes of the generated design layouts and/or selected modes. In the depicted example, the two sample spaces 302, 304 are generated to correspond to the first and second presentation sizes, respectively.

Each respective sample space is arranged relative to an origin point 306 (e.g., pixel 0, 0) in the presentation interface, according to its corresponding presentation size. In this regard, the sample space associated with presentation size having a larger width dimension may be positioned further from the origin point in a horizontal direction than a sample space associated with a presentation size having a smaller width dimension. A sample space associated with a presentation size having a larger height dimension may be positioned further from the origin point in a vertical direction than a sample space associated with a presentation size having a smaller height dimension. The respective sample spaces are displayed as being separated within the presentation interface by a number of visual partitions 308, the number of visual partitions being based on the number of respective sample spaces. In the depicted example, the number of visual partitions is equal to the number of respective sample spaces plus one. While the origin point 306 is depicted as being a visible point, the origin point may not be visible.

As depicted in FIG. 3A, a first design layout (or selected mode) is displayed in the presentation interface, within the first sample space. The user designer may then adjust the size of the first design layout while it is displayed in the presentation interface. Adjusting the design layout may include, for example, scaling the visually depicted layout of the module in one or more directions, changing the size and/or the shape of the design layout.

When the size of the first design layout (or, e.g., a first selected mode) is adjusted (e.g., scaled) to within a predetermined distance of, or to overlap, a second sample space of the respective sample spaces, a presentation algorithm may automatically change the display of the first design layout to a display of a second design layout (or, e.g., a second selected mode) having the presentation size associated with the second sample space. In this regard, the changing of the display of the first design layout may also be based on the size of the first design layout being adjusted (e.g., scaled) beyond a threshold size associated with the first sample space and in a direction toward the second sample space. FIG. 3B depicts the change to the second design layout. In some implementations, the presentation algorithm determines that the threshold size is reached or that there is sufficient overlap of the second sample space using a nearest neighbor calculation. In this regard, the user designer may dynamically adjust the size of a design and the design application shows the design dynamically switching between layouts. When the size of the design layout is adjusted inversely to revert back to below the threshold size within the first sample space, the presentation algorithm may automatically change the display of the second design layout back to the display of the first design layout.

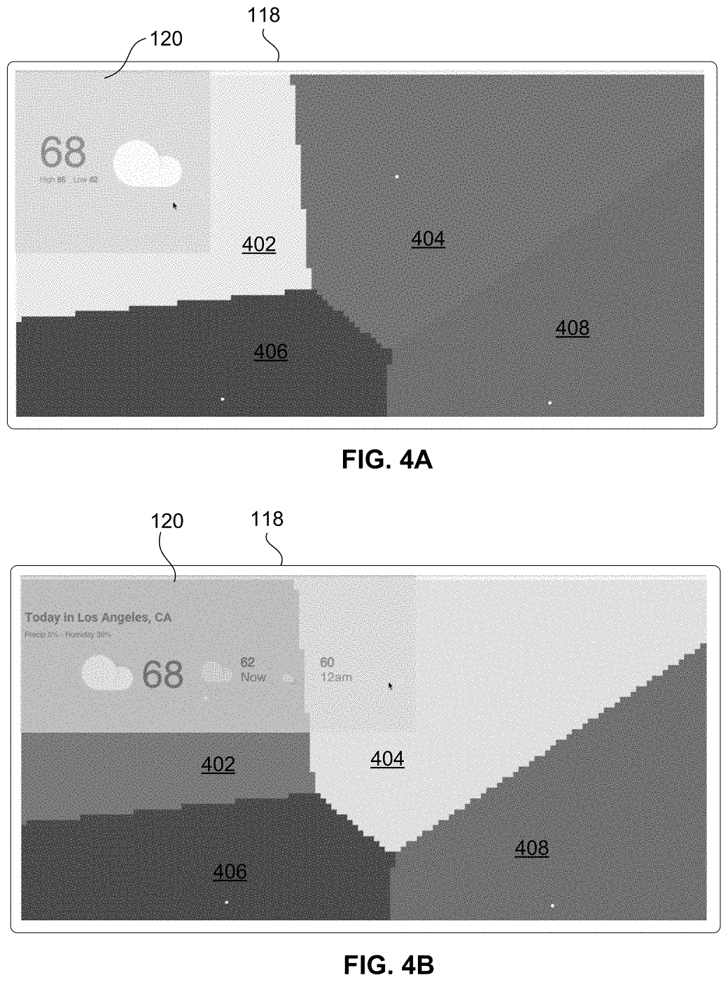

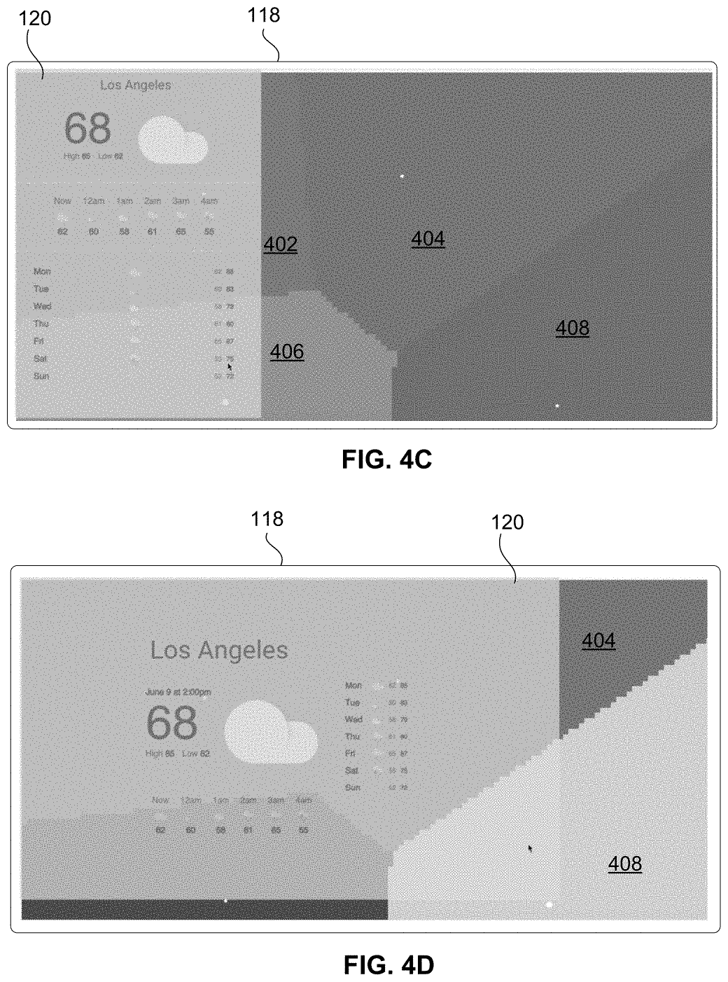

FIGS. 4A to 4D depict the presentation interface 118 with four sample spaces 402, 404, 406, 408 having been generated based on the selection of four modes for four different presentation sizes, according to various aspects of the subject technology. The user designer may generate multiple design layouts for different presentation sizes, and view each layout in the presentation interface at design time. Each time a search is performed to generate candidate modes, and a mode is selected, a new sample space is generated in the presentation interface for the presentation size of the newly-selected mode. In this regard, the presentation interface may include one, two, three, four, or more sample spaces for different presentation sizes.

For example, a user designer may have created two different design layouts for two different presentation sizes. Accordingly, there may be two respective sample spaces displayed in the presentation interface, as described above. The designer application 102 may be used to select a third presentation size for a third layout design. For example, the user designer may create a second (master) design layout for display at or up to 1600 by 400 pixels. Once arranged in the third design layout, the automated design interface 114 may then be used to automatically determine a plurality of candidate modes of the third layout design at the third presentation size, with each of third plurality of candidate modes including a selection of visual elements from the set of visual elements used for the first and second layout designs described above, but in a different arrangement (e.g., based on the decision sets). A third selected mode may then be selected and displayed in presentation interface 118 using the third design layout with the plurality of visual elements arranged according to the third mode. The fourth mode may be generated and selected in the same manner.

FIG. 4A depicts the previously described first design layout (or first selected mode) being displayed in the presentation interface 118, within a first sample space 402 that is arranged with respect to the other three sample spaces 404, 406, 408 based the respective presentation sizes associated with the four sample spaces. FIG. 4B depicts the result of a user designer adjusting the size of the first design layout while it is displayed in the presentation interface in a horizontal direction, into the adjacent sample space 404. The visually displayed design layout may be adjusted by scaling the visually depicted layout in one or more directions, changing the size and/or the shape of the design layout. As described above, when the size of the first design layout (or, e.g., a first selected mode) is adjusted (e.g., in a horizontal direction) to within a predetermined distance of, or to overlap, the second sample space 404, a presentation algorithm automatically changes the display of the first design layout to a display of a second design layout (or, e.g., a second selected mode) having the presentation size associated with the second sample space 404. In this regard, the changing of the display of the first design layout may also be based on the size of the first design layout being adjusted (e.g., scaled) beyond a threshold size associated with the first sample space 402 and in a direction toward the second sample space 404. The second design layout is shown including the visual elements of the first design layout, but arranged according to different decision sets. Also, the second design layout includes additional components (e.g., time-weather components) that appear in a row according to an option in a decision set for the second design layout, which is associated with a larger horizontal dimension than the first design layout.

FIG. 4C depicts the result of a user designer adjusting the size of the first design layout while it is displayed in the presentation interface 118 in a vertical direction, toward or into the adjacent third sample space 406. When the size of the first design layout (or, e.g., a first selected mode) is adjusted (e.g., in a vertical direction) to within a predetermined distance of, or to overlap, the third sample space 406, the presentation algorithm automatically changes the display of the first design layout to a display of a third design layout (or, e.g., a second selected mode) having the presentation size associated with the third sample space 406. In this regard, the changing of the display of the first design layout may also be based on the size of the first design layout being adjusted (e.g., scaled) beyond a threshold size associated with the first sample space 402 and in a direction toward the third sample space 406. The third design layout includes additional components (e.g., weather forecast components) that appear in a column according to an option in a decision set for the third design layout, which is associated with a larger vertical dimension than the first design layout.

FIG. 4D depicts the result of a user designer adjusting the size of a design displayed in the presentation interface 118 in a horizontal and vertical direction, toward or into the adjacent fourth sample space 408. For example, when the size of the second or third design layout is adjusted (e.g., in a horizontal and/or vertical direction) to within a predetermined distance of, or to overlap the fourth sample space 408, the presentation algorithm automatically changes the display of the design to a display of a fourth design layout (or, e.g., a fourth selected mode) having the presentation size associated with the fourth sample space 408. In this regard, the changing of the display of the design layout may also be based on the size of the design layout being adjusted (e.g., scaled) beyond a threshold size associated with a current sample space and in a direction toward the fourth sample space 408. The fourth design layout includes additional components that appear in a column, and additional component(s) that appear in a row, according to an option in a decision set for the fourth design layout, which is associated with a larger horizontal and vertical dimension than the other layouts. When the size of the design layout is adjusted inversely (in any direction) to revert back to within a threshold size associated with any one of the other sample spaces, the presentation algorithm may automatically change the display of the design layout back to the design layout associated with the sample space to which it is now associated.

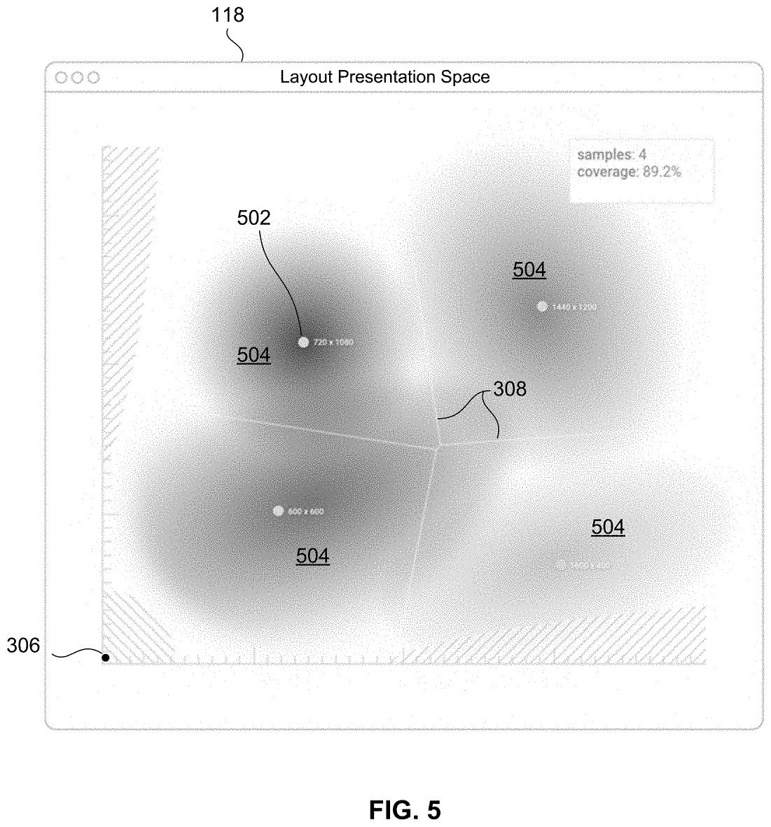

FIG. 5 depicts the presentation interface 118 including respective sample spaces, according to various aspects of the subject technology. The depicted figure is exemplary of various implementations in which the presentation interface 118 is divided into multiple sample spaces with corresponding partitions 308. Each sample space corresponds to a size of a selected mode 120 of a respective design layout generated by the design application 102. As discussed previously, the respective partitions 308 may define the maximum area within the sample space to which a respective design layout can be scaled before the respective design layout switches to a different layout design.

As depicted in FIG. 5, each sample space may include a point 502 representative of the size of the design layout for which the sample space was generated. For example, each point 502 may represent the corner of the design layout opposing the origin point 306 of the presentation interface, such that the respective x, y distance from the origin 306 to the point 502 corresponds to the layout size of the design layout represented by the sample space. The origin point 306 may be in any position within presentation interface 118. In the depicted example, the origin point 306 is in the bottom-left corner; however, origin point 306 may also be located at the top-left corner as described above, or some other predetermined coordinate location within presentation interface 118. According to various implementations, the respective partitions 308 may be generated based on a nearest neighbor calculation that takes in to account the distance between each of the respective points 502.

As depicted, each sample space may be associated with a visual cloud of elasticity 504, or cloud of points or pixels, that visually indicates, based on predetermined scoring criteria, a suitability scoring of the possible presentation sizes of a respective design layout associated with the sample space. This visual cloud is representative of the elasticity of the presentation size of the layout within the sample space, thus visually indicating a range of the presentation sizes of the design layout, and the suitability of each potential size across that range. In this regard, the visual cloud includes a saturated area that diffuses toward an outer edge of the cloud, with the saturated area corresponding to a coordinate location (in the sample space) associated with one or more of the presentation sizes having a highest suitability score for the sample space, and the score of other coordinate locations associated with other presentation sizes decreasing according to an amount of diffusion at the other coordinate locations. As depicted in FIG. 5, the coordinate locations within the visual cloud of elasticity 504 may, like point 502, represent the corner of the scaled design layout opposing the origin point 306 of the presentation interface, such that the respective x, y distance from the origin 306 to the coordinate corresponds to the prospective presentation size. In some implementations, each coordinate location within the visual cloud may be representative of other scaled locations within a given prospective presentation size.

The range of potential sizes upon which the visual cloud of elasticity 504 may be determined independently of a point 502. As described previously, the visual cloud is saturated (e.g., most dense) at a point, or points, where a size of the given design layout is most suitable for the design based on a heuristic evaluation of the design layout. The pattern of pixels (or cloud) then diffuses with respect to sizes having a decrease in suitability; with whitespace representative of the suitability having fallen below an acceptable threshold of suitability. As depicted in FIG. 5, the pattern may be most dense at or near the respective point 502 for the same sample space (and/or design layout) associated with the pattern, but this may not be the case in all examples.

Software heuristic evaluators run in the background in real time and calculate the domain of suitability for the given layout at the various presentation sizes within the sample space and then, as shown in FIG. 5, the design application 102 visually depicts this evaluation as a visual cloud, or colored region. In this regard, the software heuristic evaluators score the suitability of the respective design layout at a given presentation size by evaluating each possible size (within the sample space) of the selected mode against one or more scoring factors. As described further below, the scoring factors include whether the characteristics of the layout at a given size meets certain criterion. The designer application 102 advances rectangle size variation within the sample space, and tests all of the potential sizes of a mode at a high frequency in a background process to determine the area of elasticity for a given layout, which is then displayed as a visual cloud. According to various implementations, each visual cloud of elasticity 504 includes a colored field. This colored field represents that sample space's coordinate score by color (Hue, Saturation, Value (HSV)) with the field's pattern of diffusion providing an indication of the suitability of a size of the selected mode 120 at each point within the pattern. Where multiple sample spaces have been generated within the presentation interface 118, a different color may be assigned to each respective sample space.

The software heuristic evaluators may, for example, score the layout of a selected mode (or design layout, in general) at a given presentation size based on various scoring factors including, for example, the type or number of elements associated with the layout, amount of whitespace, proximity of elements, whether the elements are fully displayable as the layout is scaled over different presentation sizes or a range of presentation sizes, and the like. Layouts may also be scored at runtime by automated design interface 114 when generating the candidate modes 116. In this regard, the automated design interface 114 may rank the candidate modes 116 based on the scores when displaying the candidate modes for selection by the user designer.

With further reference to the visual clouds 504 depicted in FIG. 5, evaluating a layout against the scoring factors may include evaluating the design layout of the selected mode at that size against one or more cost functions. Table 1, below, describes example cost functions for scoring a layout of a selected mode. Each of these cost functions may include tolerances and other parameters that are configurable by a user designer within designer application 102. A layout may be assigned a default score. The respective cost functions may be implemented such that they adjust the score lower or higher, and some cost functions may counterbalance other cost functions that drive the score in the other direction. The example cost functions may be used to penalize a respective score, e.g., by increasing the score, with a higher score being worse than a lower score. In some implementations, a respective score may be penalized by decreasing the score, with a lower score being worse than a higher score. Each penalty may also be configurable within the designer application 102.

TABLE 1

| Function | | Description |
|---|---|---|
| 1. | Conflicts: | Penalty for every time there is a conflict in the design |
| | | layout, such as a pair of properties cannot be displayed in |
| | | the UI at the same time. For example, a group having more |
| | | than one background image. |
| 2. | Consistency: | Penalty for any property that differs from the majority |
| | | value for that property across the layout. For example, |
| | | three red items and one blue. |
| 3. | Sibling consistency: | Same as (3), but only compares items which are siblings |
| | | within a group, and only compares a few specific |
| | | properties (main axis alignment, cross axis alignment, text |
| | | alignment, text spacing, item spacing) |
| 4. | Empty space: | Penalty for any space within the bounds of the display that |
| | | isn′t covered by an item. |
| 5. | Offscreen clip: | Penalty for any space outside the bounds of the display that |
| | | is covered by an item, and cannot be accessed by scrolling. |
| 6. | Offscreen scroll: | Penalty for any space outside the bounds of the display that |
| | | is covered by an item, and can be accessed by scrolling. |
| 7. | Sibling overlap: | Penalty for any siblings within a group in the layout that |
| | | overlap each other. |
| 8. | Glyph min padding: | Penalty for any items which are too close to the edge of the |
| | | display |
| 9. | Weak relationships: | Penalty for any creator-provided relationships between |
| | | items that are not met. For example, the creator specified a |
| | | relationship between items A and B where A should be |
| | | wider than B, and in the UI B is wider than A. Only |
| | | applies to relationships where the creator specified the |
| | | priority as “weak”. |
| 10. | Medium | Same as (9), only applies to relationships where the creator |
| | relationships: | specified the priority as “medium”. |
| 11. | High relationships: | Same as (9), only applies to relationships where the creator |
| | | specified the priority as “high”. |
| 12. | Required | Same as (9), only applies to relationships where the creator |
| | relationships: | specified the priority as “required”. |
| 13. | Nested scrolling: | Penalty for any nested scrolling items where either the |
| | | scroll direction is the same, or the inner scrolling area is |
| | | greater than half the outer scrolling area. |
| 14. | Tap target size: | Penalty for any tappable items which are too small to be |
| | | considered usable. |
| 15. | Text contrast: | Penalty for any text which does not have a high enough |
| | | contrast with its background. (currently, only a very |
| | | minimal version of this one is actually implemented) |
| 16. | Local left alignment: | Penalty for any sibling pair within a group whose left |
| | | edges do not fall at the same point along the x-axis. |
| 17. | Local top alignment: | Same as (16), along the y-axis. |
| 18. | Global left | Penalty for any item pair whose left edges do not fall at the |
| | alignment: | same point along the x-axis. |
| 19. | Global top | Same as (18), along the y-axis. |
| | alignment: | |
| 20. | Near left alignment: | Penalty for any item pair whose left edges are close to, but |
| | | not exactly, on the same point along the x-axis. |
| 21. | Near top alignment: | Same as (20), along the y-axis. |
| 22. | Non-centered | Penalty for any group children which are not close to the |
| | children: | center of their parent group. |
| 23. | Non-edge children: | Penalty for any group children which are not close to an |
| | | edge of their parent group. |
| 24. | Tap target spacing: | Penalty for any tappable items which are too close together |
| | | to be considered usable. |
| 25. | Visual weight: | Penalty for any item pair which has a creator-provided |
| | | visual weight relationship, where that relationship is not |
| | | met. (currently, only a very minimal version of this one is |
| | | actually implemented) |
| 26. | Overlay positioning: | Penalty for any background images which have both their |
| | | top and bottom edges overlapped by content. |
| 27. | Visible list items: | Penalty for any visible lists which do not have at least |
| | | three visible items. |
| 28. | Clipped lists: | Penalty for any visible lists whose last visible item is not |
| | | partially clipped offscreen. |
| 29. | Unused items: | Penalty for any items in the original design which do not |
| | | appear in this particular UI. |

A visual cloud of elasticity 504 (or area of elasticity) displayed for even one sample space may be used by a user designer to visually evaluate the suitability of the layout of a currently selected mode 120. For example, with reference to FIG. 5, the user designer may have selected a mode 120 having size of 1440×1200. In this example, there could be no partitions 308 with only the depicted visual cloud 504 in the upper right quadrant being generated. The user designer could then perform a visual gap analysis based on the diffusion pattern of the visual cloud 504 and the corresponding white space in the other quadrants, and conclude that other design layouts of different sizes may be possible, or perhaps more suited, for the software application using the layout. In some implementations, presentation interface 118 includes instructions that run in real time, in the background, that generate and visually depict the score at the relative position of the cursor within a sample space or visual cloud. This way, the user designer may move the cursor within a sample space to further determine the scores generated and the suitability of her current design layout for a given application.

The user designer may add, subtract, or move sample points 502 to, from, or within a sample space to modify presentation interface 118. According to some implementations, a sample point 502 may be added to generate a new visual cloud of elasticity based on a design layout of a size corresponding to the new point. The user designer may add the new sample point 502 for further layout definition and generation of a new partition 308. In this regard, sample points 502 may be added to further define the presentation interface 118 and its partitions without generating new visual clouds of elasticity. Existing visual clouds may be modified or used by the user to evaluate the newly added sample space(s). Additionally or in the alternative, the user designer may add the new sample point 502 by selecting a mode 120 from several candidate design modes 116 that the designer application 102 suggests for further work based on commonly used rectangle sizes and a current elasticity map for all current samples. As the user designer adds samples (e.g., by selecting a mode for a given presentation size), the designer application 102 generates a sample space and begins searching nearby coordinates of the presentation interface 118 for suitability of the sample within the sample space corresponding to the sample and generates a visual cloud of elasticity for the sample.

In one example scenario, a first identification of a location within the presentation interface 118 may be received for placement of a new sample point, along with a second identification of a new presentation size associated with the new sample point. In response, the software heuristic evaluators evaluate the overall space, and software (e.g., executable instructions 108) automatically adds a new sample space corresponding to the new presentation size associated with the new sample point to the respective sample spaces, and automatically adjusts the areas of the displayed sample sizes within the presentation interface 118 to accommodate a display of the new sample space within the presentation interface.

In another example scenario, a user designer defines a layout for a common portrait phone device by adding all possible atoms and components, editing their information architecture hierarchy, and creating a schematic visual arrangement of elements using the design tool 112. Layouts are generated by the automated design interface 114, and she selects one having a portrait presentation size for a mobile smart phone. Next, the user designer adds a new sample for a landscape tablet rectangle size (e.g., at a different orientation). The designer application 102 immediately begins generating layouts based on the existing state of the working surface, and the user designer begins browsing candidate layouts without modifying the working surface state or affecting existing information architecture. The layouts may be very close, with one grouping of actions not working well in any of the candidate layouts. The user designer then rearranges them slightly on the working surface and the designer application software immediately picks up the change. She selects the tablet landscape layout, and the designer application 102 begins calculating that sample's elasticity for display in presentation interface 118.

Next, according to the example scenario, the user designer adds three more sample points to the presentation interface 118, and without returning to the working surface or layout browsers. The user designer can see the relative suitability of the current specification for her layout when the system extrapolates the interface to add the new samples. She continues work in this manner, tweaking wireframes for each sample, and adding (and sometimes removing) samples to achieve good overall coverage of rectangle sizes.

Selected design layouts may then be deployed to various devices. In some implementations, multiple design layouts at different orientations (e.g., landscape and portrait) may be deployed to the same device. In this regard, the device may switch between the design layouts developed by designer application 102 in a normal manner, for example, by changing the orientation of the device, or by manually scaling the user interface associated with the design layouts. Additionally, in some implementations, the technology related to presentation interface 118 described with respect to FIG. 5 (e.g., software heuristic evaluators, ability to test elasticity, etc.) may also be deployed on the end user device to evaluate performance of the design layouts deployed on the device. In this regard, the design layouts may be scored (e.g., based on the foregoing cost functions) with respect to the display area of the device or application operating on the device, and/or used to perform the foregoing gap analysis. As a result, contextualized individual reports may be provided to end users to provide an indication of success or failure of the design layouts and to obtain end-user feedback regarding the design layouts.

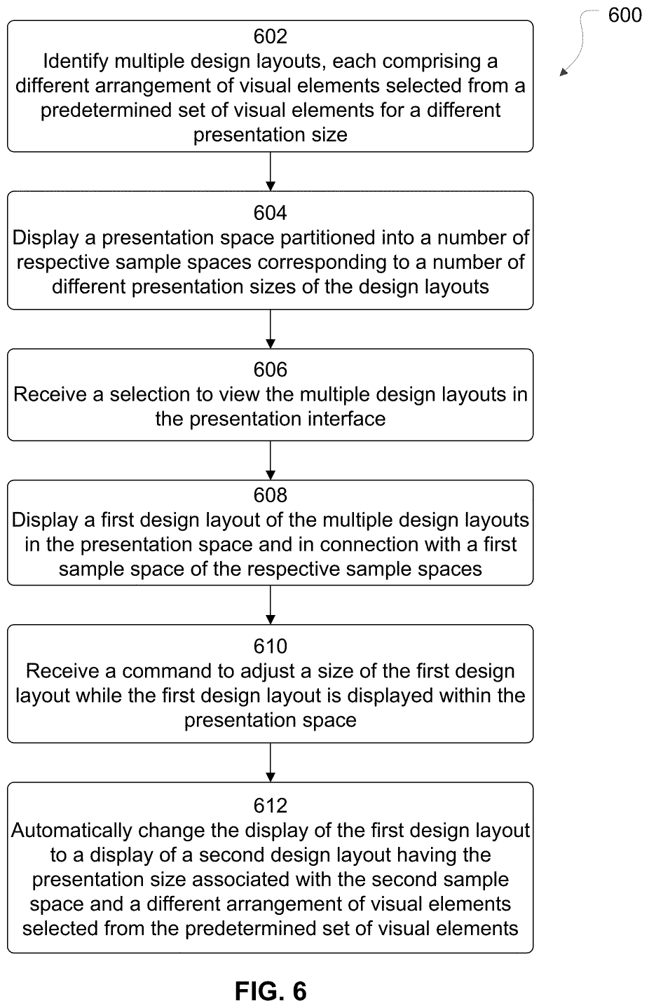

FIG. 6 depicts an example process for the quick generation and selection of visual layouts for graphically displayable design layouts, according to aspects of the subject technology. For explanatory purposes, the various blocks of example process 600 are described herein with reference to FIGS. 1-5, and the components and/or processes described herein. The one or more of the blocks of process 500 may be implemented, for example, by computing device 106, including a processor and other components utilized by device 106. In some implementations, one or more of the blocks may be implemented apart from other blocks, and by one or more different processors or devices. Further for explanatory purposes, the blocks of example process 500 are described as occurring in serial, or linearly. However, multiple blocks of example process 500 may occur in parallel. In addition, the blocks of example process 600 need not be performed in the order shown and/or one or more of the blocks of example process 600 need not be performed.

In the depicted example flow diagram, a designer application 102 identifies multiple design layouts, each comprising a different arrangement of visual elements selected from a predetermined set of visual elements for a different presentation size (602). The multiple design layouts may first be generated as described above, by designing a master design layout using design tool 112, generating multiple candidate design modes for respective presentation sizes using automated design interface 114, and selecting a mode for each presentation size. The various presentations sizes may be for multiple different orientations. Each selected mode is then identified by the designer application 102 as a design layout for display in a presentation interface 118. Based on identifying the design layouts, designer application 102 calculates and displays the presentation interface partitioned into a number of respective sample spaces corresponding to a number of different presentation sizes of the design layouts (604). FIGS. 3A and 3B depict the presentation interface 118 with two sample spaces for display of two different modes 120. FIGS. 4A to 4D depict the presentation interface 118 with four sample spaces for four different modes 120.

In the depicted example, designer application then receives a selection to view the multiple design layouts in the presentation interface 118 (606). In response to receiving the selection, and/or in connection with displaying the presentation interface, designer application 102 displays a first design layout of the multiple design layouts in the presentation interface 118 (at, e.g., a first orientation) and in connection with a first sample space of the respective sample spaces (608). The first design layout may be displayed by activating a control, after the first design layout has been created by a user designer in the design tool 112, or may be displayed by selecting (and, e.g., activating the control) a design mode for the first design layout from a plurality of candidate modes for the first design layout.

While displaying the first design layout, the designer application 102 receives a command to adjust a size of the first design layout while the first design layout is displayed within the presentation interface (610). The visually displayed design layout may be adjusted by scaling the visually depicted layout in one or more directions, changing the size and/or the shape and/or the orientation of the design layout. In response to the size of the first design layout being adjusted (e.g., scaled) to within a predetermined distance of, or to overlap, a second sample space of the respective sample spaces, the designer application 102 automatically changes the display of the first design layout to a display of a second design layout (at, e.g., a second orientation) having the presentation size associated with the second sample space and a different arrangement of visual elements selected from the same predetermined set of visual elements than the first design layout (612). The change may occur, for example, due to scaling of the visually displayed layout in a single direction, or mostly in a single direction (e.g., toward an adjacent sample space). The changing of the display of the first design layout may also be based on the size of the first design layout being adjusted (e.g., scaled) beyond a threshold size associated with the first sample space and in a direction toward the second sample space.

FIG. 3A, for example, depicts an example scenario in which the number of respective sample spaces is two. Optionally, the designer application 102 may receive a receive a selection of a third presentation size for a third layout design, and generate a third layout design based on a third selected mode. In response to generating the third layout design, the designer application automatically changes the number of respective sample spaces to three. Another presentation size and corresponding layout may be generated, and a corresponding mode selected, and the designer application may automatically change the number of respective sample spaces to four for viewing of the fourth design layout, as shown in FIG. 4D.

Many of the above-described example 600, and related features and applications, may also be implemented as software processes that are specified as a set of instructions recorded on a computer readable storage medium (also referred to as computer readable medium), and may be executed automatically (e.g., without user intervention). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

The term “software” is meant to include, where appropriate, firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

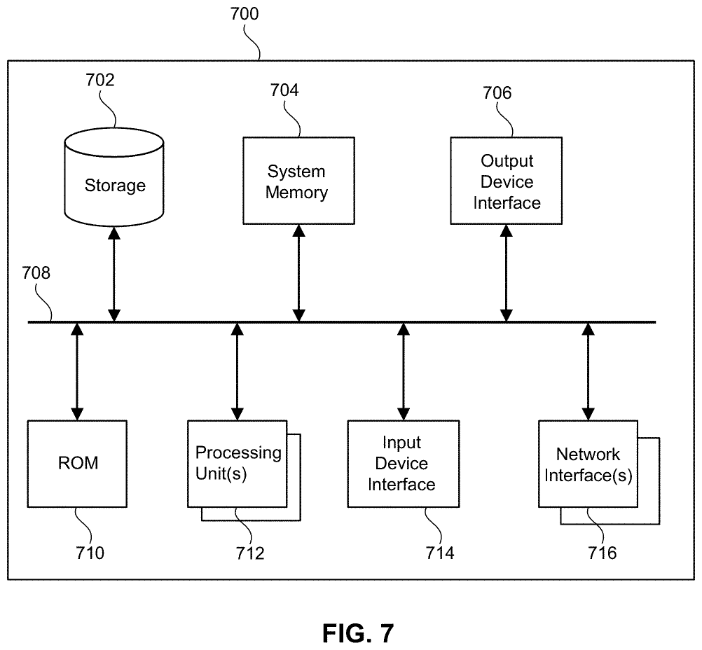

FIG. 7 is a diagram illustrating an example electronic system 700 for the quick generation and selection of visual layouts for graphically displayable design layouts, according to one or more aspects of the subject technology. Electronic system 700 may be a computing device for execution of software associated with one or more portions or steps of process 700, or components and processes provided by FIGS. 1-3. Electronic system 700 may be representative, in combination with the disclosure regarding FIGS. 1-6, of computing device 106. In this regard, electronic system 700 or (computing device 106) may be a personal computer or a mobile device such as a smartphone, tablet computer, laptop, PDA, an augmented reality device, a wearable such as a watch or band or glasses, or combination thereof, or other touch screen or television with one or more processors embedded therein or coupled thereto, or any other sort of computer-related electronic device having network connectivity.

Electronic system 700 may include various types of computer readable media and interfaces for various other types of computer readable media. In the depicted example, electronic system 700 includes a bus 708, processing unit(s) 712, a system memory 704, a read-only memory (ROM) 710, a permanent storage device 702, an input device interface 714, an output device interface 706, and one or more network interfaces 716. In some implementations, electronic system 700 may include or be integrated with other computing devices or circuitry for operation of the various components and processes previously described.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, e.g., alphanumeric keyboards and pointing devices (also called “cursor control devices”). Output device interfaces 706 enables, e.g., the display of images generated by the electronic system 700. Output devices used with output device interface 706 include, e.g., printers and display devices, such as cathode ray tubes (CRT) or liquid crystal displays (LCD). Some implementations include devices such as a touchscreen that functions as both input and output devices.

Finally, as shown in FIG. 7, bus 708 also couples electronic system 700 to a network (not shown) through network interfaces 716. Network interfaces 716 may include, e.g., a wireless access point (e.g., Bluetooth or WiFi) or radio circuitry for connecting to a wireless access point. Network interfaces 716 may also include hardware (e.g., Ethernet hardware) for connecting the computer to a part of a network of computers such as a local area network (“LAN”), a wide area network (“WAN”), wireless LAN, or an Intranet, or a network of networks, such as the Internet. Any or all components of electronic system 700 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, etc. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method, comprising:
identifying multiple design layouts, each comprising a different arrangement of visual elements selected from a predetermined set of visual elements for a different presentation size;
displaying, based on the multiple design layouts, a presentation interface partitioned into a number of respective sample spaces corresponding to the different presentation sizes of the design layouts;
receiving a selection to view the multiple design layouts in the presentation interface;
displaying, responsive receiving the selection, a first design layout of the multiple design layouts in the presentation interface and in connection with a first sample space of the respective sample spaces;
receiving a command to adjust a size of the first design layout while the first design layout is displayed within the presentation interface; and
in response to the size of the first design layout being adjusted to within a predetermined distance of, or to overlap, a second sample space of the respective sample spaces, automatically changing the display of the first design layout to a display of a second design layout having the presentation size associated with the second sample space and having a different arrangement of visual elements selected from the predetermined set of visual elements than the first design layout.

2. The method of claim 1, wherein each of the respective sample spaces is arranged relative to an origin point in the presentation interface, according to its corresponding presentation size, with a sample space associated with presentation size having a larger width dimension being positioned further from the origin point in a horizontal direction than a sample space associated with a presentation size having a smaller width dimension, and a sample space associated with a presentation size having a larger height dimension being positioned further from the origin point in a vertical direction than a sample space associated with a presentation size having a smaller height dimension.

3. The method of claim 2, wherein the respective sample spaces are displayed as being separated within the presentation interface by a number of visual partitions, the number of visual partitions based on the number of respective sample spaces.

4. The method of claim 3, wherein a height or width dimension of a respective sample space changes within the presentation interface with respect to one or more of the visual partitions that border the respective sample space, the height or width dimension of the respective sample space being proportional to the height or width dimension of its associated presentation size with respect to the height or width of presentation sizes of other sample spaces in the presentation interface along a same dimension.

5. The method of claim 4, wherein the changing of the display of the first design layout is also based on the size of the first design layout being adjusted beyond a threshold size associated with the first sample space and in a direction toward the second sample space, wherein the threshold size associated with the first sample space is defined by a changing height dimension and a changing width dimension of the first sample space according to at least one visual partition that borders the first sample space.

6. The method of claim 3, wherein the presentation interface is partitioned into three or more respective sample spaces.

7. The method of claim 1, further comprising:
generating, for a first sample space of the respective sample spaces, a visual cloud of points or pixels that visually indicates, based on predetermined scoring criteria, a suitability scoring of respective presentation sizes of a respective design layout associated with the first sample space, the visual cloud including a saturated area that diffuses toward an outer edge of the cloud,
wherein the saturated area corresponds to a coordinate location associated with one or more of the respective presentation sizes having a highest suitability score for the first sample space, and wherein the score of other coordinate locations associated with other of the respective presentation sizes decrease according to an amount of diffusion at the other coordinate locations.

8. The method of claim 1, further comprising:
receiving a first identification of a location within the presentation interface for placement of a new sample point, and a second identification of a new presentation size associated with the new sample point; and
automatically adding to the respective sample spaces, in response to receiving the first and second identifications, a new sample space corresponding to the new presentation size associated with the new sample point, and automatically adjusting displayed areas of the respective sample spaces within the presentation interface to accommodate a display of the new sample space within the presentation interface.

9. The method of claim 1, wherein generating multiple design layouts comprises:
receiving a selection of a first presentation size and a plurality of visual elements for the first design layout at the first presentation size, and a first plurality of display options for one or more of the plurality of visual elements;
automatically determining a first plurality of candidate modes of the first design layout at the first presentation size, each of the first plurality of candidate modes comprising the same set of visual elements but in a different arrangement for the first design layout according to the first plurality of display options;
receiving a selection of a first mode of the first plurality of candidate modes for the first design layout, wherein displaying the first design layout comprises displaying the first design layout with the plurality of visual elements arranged according to a first arrangement;
receiving a selection of a second presentation size for a second layout design, and a second plurality of display options for one or more of the plurality of visual elements;
automatically determining a second plurality of candidate modes of the second layout design at the second presentation size, each of second plurality of candidate modes comprising the same set of visual elements but in a different arrangement for the second layout design according to the second plurality of display options; and
receiving a selection of a second mode of the second plurality of candidate modes for the second design layout, wherein displaying the second design layout comprises displaying the second design layout with the plurality of visual elements arranged according to a second arrangement.

10. The method of claim 9, wherein the number of respective sample spaces is two, the method further comprising:
receiving a selection of a third presentation size for a third design layout;
generating the third design layout based on a third mode; and
automatically changing, in response to generating the third design layout, the number of respective sample spaces to three.

11. A system, comprising:
one or more processors; and
a memory comprising instructions stored thereon that, when executed by the one or more processors, cause the one or more processors to perform operations comprising:
generating multiple design layouts, each comprising a different arrangement of visual elements selected from a predetermined set of visual elements for a different presentation size;
displaying, based on the multiple design layouts, a presentation interface partitioned into a number of respective sample spaces corresponding to the different presentation sizes of the design layouts;
displaying, in connection with displaying the presentation interface, a first design layout of the multiple design layouts in the presentation interface and in connection with a first sample space of the respective sample spaces;
receiving a command to adjust a size of the first design layout while the first design layout is displayed within the presentation interface; and
in response to the size of the first design layout being adjusted to within a predetermined distance of, or to overlap, a second sample space of the respective sample spaces, automatically changing the display of the first design layout to a display of a second design layout having the presentation size associated with the second sample space and having a different arrangement of visual elements selected from the predetermined set of visual elements than the first design layout.

12. The system of claim 11, wherein each of the respective sample spaces is arranged relative to an origin point in the presentation interface, according to its corresponding presentation size, with a sample space associated with presentation size having a larger width dimension being positioned further from the origin point in a horizontal direction than a sample space associated with a presentation size having a smaller width dimension, and a sample space associated with a presentation size having a larger height dimension being positioned further from the origin point in a vertical direction than a sample space associated with a presentation size having a smaller height dimension.

13. The system of claim 12, wherein the respective sample spaces are displayed as being separated within the presentation interface by a number of visual partitions, the number of visual partitions based on the number of respective sample spaces.

14. The system of claim 13, wherein a height or width dimension of a respective sample space changes within the presentation interface with respect to one or more of the visual partitions that border the respective sample space, the height or width dimension of the respective sample space being proportional to the height or width dimension of its associated presentation size with respect to the height or width of presentation sizes of other sample spaces in the presentation interface along a same dimension.

15. The system of claim 14, wherein the changing of the display of the first design layout is also based on the size of the first design layout being adjusted beyond a threshold size associated with the first sample space and in a direction toward the second sample space, wherein the threshold size associated with the first sample space is defined by a changing height dimension and a changing width dimension of the first sample space according to at least one visual partition that borders the first sample space.

16. The system of claim 13, wherein the presentation interface is partitioned into three or more respective sample spaces.

17. The system of claim 11, wherein the operations further comprise:
generating, for a first sample space of the respective sample spaces, a visual cloud of points or pixels that visually indicates, based on predetermined scoring criteria, a suitability scoring of respective presentation sizes of a respective design layout associated with the first sample space, the visual cloud including a saturated area that diffuses toward an outer edge of the cloud,
wherein the saturated area corresponds to a coordinate location associated with one or more of the respective presentation sizes having a highest suitability score for the first sample space, and wherein the score of other coordinate locations associated with other of the respective presentation sizes decrease according to an amount of diffusion at the other coordinate locations.

18. The system of claim 17, wherein the operations further comprise:
receiving a first identification of a location within the presentation interface for placement of a new sample point, and a second identification of a new presentation size associated with the new sample point; and
automatically adding to the respective sample spaces, in response to receiving the first and second identifications, a new sample space corresponding to the new presentation size associated with the new sample point, and automatically adjusting displayed areas of the respective sample spaces within the presentation interface to accommodate a display of the new sample space within the presentation interface.

19. A non-transitory computer-readable medium having instructions stored thereon that, when executed, cause a computing device to perform a method, comprising:
identifying multiple design layouts, each comprising a different arrangement of visual elements selected from a predetermined set of visual elements for a different presentation size;
displaying, based on the multiple design layouts, a presentation interface partitioned into a number of respective sample spaces corresponding to the different presentation sizes of the design layouts;
displaying, in connection with displaying the presentation interface, a first design layout of the multiple design layouts in the presentation interface and in connection with a first sample space of the respective sample spaces;
receiving a command to adjust a size of the first design layout while the first design layout is displayed within the presentation interface; and
in response to the size of the first design layout being adjusted to within a predetermined distance of, or to overlap, a second sample space of the respective sample spaces, automatically changing the display of the first design layout to a display of a second design layout having the presentation size associated with the second sample space and having a different arrangement of visual elements selected from the predetermined set of visual elements than the first design layout.

20. The non-transitory computer-readable medium of claim 19, wherein each of the respective sample spaces is arranged in the presentation interface, according to its corresponding presentation size, and the respective sample spaces are displayed as being separated within the presentation interface by a number of visual partitions, the number of visual partitions being based on the number of respective sample spaces, wherein a height or width dimension of a respective sample space changes within the presentation interface with respect to one or more of the visual partitions that border the respective sample space, the height or width dimension of the respective sample space being proportional to the height or width dimension of its associated presentation size with respect to the height or width of presentation sizes of other sample spaces in the presentation interface along a same dimension, and
wherein the method further comprises:
generating a new design layout at a new presentation size; and
automatically adding to the respective sample spaces, in response to generating the new design layout at the new presentation size, a new sample space corresponding to the new presentation size, and automatically adjusting displayed areas of the respective sample spaces within the presentation interface to accommodate a display of the new sample space within the presentation interface.
